(19) United States
(12) Patent Application Publication
(10) Pub. No.: US 2026/0141024 A1
(43) Pub. Date: May 21, 2026

(54) ARITHMETIC UNIT

(71) Applicants: Fujitsu Limited, Kawasaki-shi (JP); Inter-University Research Institute Corporation Research Organization of Information and Systems, Tokyo (JP)

(72) Inventors: Masahiro GOSHIMA, Chiyoda (JP); Yi Ge, Bunkyo (JP)

(73) Assignees: Fujitsu Limited, Kawasaki-shi (JP); Inter-University Research Institute Corporation Research Organization of Information and Systems, Tokyo (JP)

(21) Appl. No.: 19/394,026

(22) Filed: Nov. 19, 2025

(30) Foreign Application Priority Data
Nov. 20, 2024 (JP) 2024-202627

(51) Int. Cl. G06F 17/16

(52) U.S. Cl. CPC G06F 17/16

(57) ABSTRACT

An arithmetic unit that executes matrix multiplication operation C=A×B or matrix multiply-accumulate operation C=A×B+Cin, the arithmetic unit including the matrix A regarded as being divided into blocks Aᵢₖ each being an l×1 column vector, the matrix B regarded as being divided into blocks Bₖⱼ each being a 1×m row vector, accumulating l×m outer products of the blocks Aᵢₖ and the blocks Bₖⱼ in a processing tile including l×m processing elements performing element-wise multiply-accumulate operation on the matrices, and executing output-stationary systolic-array-based operation in units of the processing tile across an entirety of the arithmetic unit.

### CROSS-REFERENCE TO RELATED APPLICATION

This application is based upon and claims the benefit of priority of the prior Japanese Patent application No. 2024-202627, filed on Nov. 20, 2024, the entire contents of which are incorporated herein by reference.

### FIELD

The embodiment discussed herein is related to an arithmetic unit.

### BACKGROUND

In particular, in application such as Artificial Intelligence (AI), it is important to improve speed and power efficiency of a matrix multiply-accumulate (MMA) arithmetic operation on elements with low accuracy such as FP16 (16-bit floating-point number). In recent years, MMA units have tended to become larger in scale in order to support, for example, Large Language Models (LLMs).

Typical conventional MMA units can be categorized into Single Instruction/Multiple Data stream (SIMD)-based and Systolic Array (SA)-based units.

An outer-product SIMD-based MMA unit and an output-stationary SA-based MMA unit each execute an MMA operation based on outer products (i.e., direct products) not on cross products. The following expression represents an outer product operation. Hereinafter, the outer-product SIMD-based MMA unit and an output-stationary SA-based MMA unit are simply referred to as a SIMD-based MMA unit and an SA-based MMA unit, respectively.

$$u ⊗ v = {uv}^{T} = ( \begin{matrix}{u}_{1} \\ {u}_{2} \\ {u}_{3} \\ {u}_{4}\end{matrix} ) ( \begin{matrix}{v}_{1} & {v}_{2} & {v}_{3} ) =\end{matrix} ( \begin{matrix}{u}_{1} {v}_{1} & {u}_{1} {v}_{2} & {u}_{1} {v}_{3} \\ {u}_{2} {v}_{1} & {u}_{2} {v}_{2} & {u}_{2} {v}_{3} \\ {u}_{3} {v}_{1} & {u}_{3} {v}_{2} & {u}_{3} {v}_{3} \\ {u}_{4} {v}_{1} & {u}_{4} {v}_{2} & {u}_{4} {v}_{3}\end{matrix} ) \qquad [ Math 1 ]$$

Both SIMD-based and SA-based MMA units share the following features in common: each of them is composed of a two-dimensional array of processing elements (PEs) that have Fused Multiply-Add (FMA) unit for the matrix elements. In addition, when they execute matrix multiplication operation C=A×B or matrix multiply-accumulate (MMA) operation C=A×B+Cin, A and B are input from the edges of the array, and C is accumulated in accumulators provided in respective PEs.

For example, a related art is disclosed in Japanese National Publication of International Patent Application No. 2021-508125.

### SUMMARY

According to an aspect of the embodiment, an arithmetic unit that executes matrix multiplication operation C=A×B or matrix multiply-accumulate operation C=A×B+Cin, the arithmetic unit including the matrix A regarded as being divided into blocks Aᵢₖ each being an l×1 column vector, the matrix B regarded as being divided into blocks Bₖⱼ each being a l×m row vector, accumulating l×m outer products of the blocks Aᵢₖ and the blocks Bₖⱼ in a processing tile including l×m processing elements performing element-wise multiply-accumulate operation on the matrices, and executing output-stationary systolic-array-based operation in units of the processing tile across an entirety of the arithmetic unit.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating L×M×N matrix multiply-accumulation;

FIG. 2 is a diagram illustrating an example of an outer-product SIMD-based matrix multiply-accumulate unit of a related example;

FIG. 3 is a diagram illustrating an example of an output-stationary SA-based matrix multiply-accumulate unit of a related example;

FIG. 4 is a diagram illustrating a matrix multiply-accumulate operation and a block matrix multiply-accumulate operation;

FIG. 5 is a diagram illustrating an example of operation of a block SA unit according to an example of an embodiment;

FIG. 6 is a diagram schematically illustrating an example of the configuration of the block SA unit of the embodiment;

FIG. 7 is a diagram illustrating a comparison of pipelined operation of matrix multiply-accumulate units of respective schemes;

FIG. 8 is a diagram schematically illustrating an example of the configuration of a rectangular outer-product matrix multiplier;

FIG. 9 is a diagram schematically illustrating an example of the configuration of a rectangular outer-product matrix multiplier including Processing Tiles (PTs) according to a modification; and

FIG. 10 is a graph illustrating a comparison in area/electricity efficiency between a matrix multiply-accumulate unit of the related art and the block SA unit of the embodiment.

### DESCRIPTION OF EMBODIMENT(S)

Since an SA-based MMA unit sequentially transfers input data (A, B) to the consecutive PEs in a bucket brigade manner, the entire arithmetic unit has a repetitive structure of PEs, thereby maintaining substantially constant efficiency even when scaled up. However, an SA-based MMA unit requires FFs (Flip-Flops) in each PE to perform bucket-brigade transfer of input data to the consecutive PEs, which degrades the area- and energy-efficiency. In short, an SA-based MMA unit can be regarded as inefficient but scalable. In addition, an SA-based MMA unit has a long latency given by the array size.

A SIMD-based MMA unit broadcasts input data (A, B) to all PEs in the rows and columns, respectively, which eliminates FFs that an SA-based unit requires for bucket-brigade transfer. As a result, a SIMD-based MMA unit can increase the area- and energy-efficiency. In addition, a SIMD-based MMA unit has a low latency. On the other hand, a SIMD-based MMA unit suffers from large area and energy consumption for broadcasting at large scales. In short, a SIM-based unit can be regarded as efficient but not scalable.

### RELATED EXAMPLE

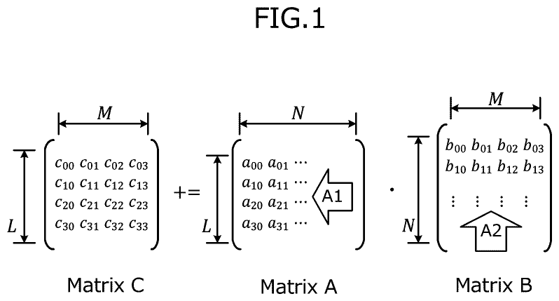

FIG. 1 is a diagram illustrating L×M×N matrix multiply-accumulation.

The expression of a matrix operation illustrated in FIG. 1 indicates that A is an L×N matrix (i.e., a matrix of L rows by N columns), B is an N×M matrix, C is an L×M matrix, and the matrix obtained by calculation A×B+C is substituted into the matrix C for the next iteration.

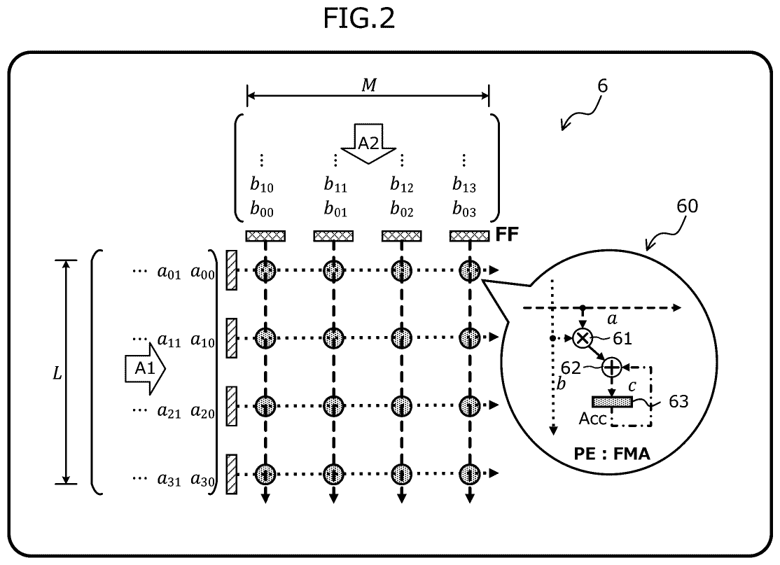

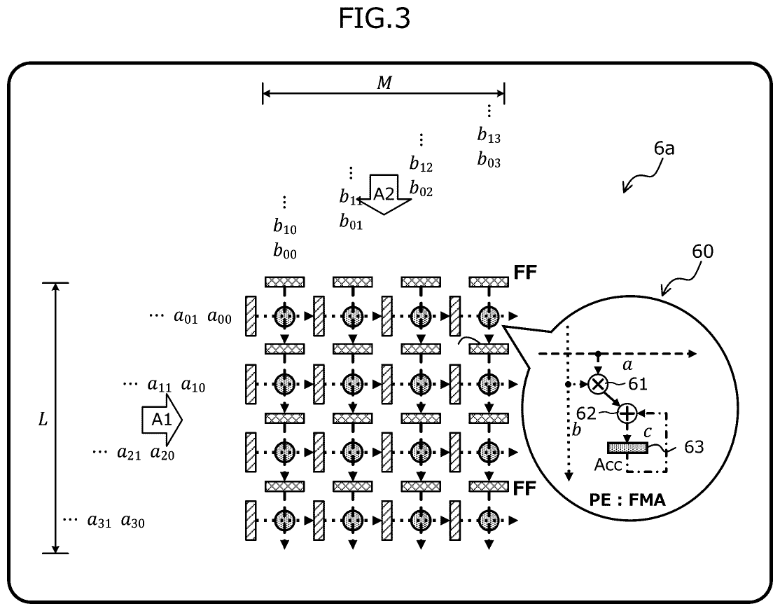

Arrows indicated by reference signs A1 in matrix A and A2 in matrix B will be described in detail below with reference to FIGS. 2 and 3.

The example of FIG. 1 assumes that L=M (=4), which alternatively may be L≠M.

FIG. 2 is a diagram illustrating an example of an outer-product SIMD-based MMA unit 6 of a related example;

In the SIMD-based MMA unit 6 illustrated in FIG. 2, processing elements (PEs) 60 each of which has an EMA unit are arranged in an L×M array. The cross-hatched rectangles and the hatched rectangles in FIG. 2 each represent a FF.

One column of a₊ₖ and one row of bₖ₊ are broadcasted in row and column directions, respectively. The arrows with reference signs A1 and A2 in FIG. 2 are the same as the arrows with reference signs A1 and A2 in FIG. 1, and indicate that the matrices A and B are inverted and then broadcasted.

A PE 60 at the intersection point of broadcasting carries out multiplication of broadcasted input and outputs the cumulative sum (accumulation) to cᵢⱼ. This multiplication and accumulation is repeated N times. The PE 60 includes a multiplier 61 and an adder 62 for EMA operation, and an accumulator (Acc) 63.

FIG. 3 is a diagram illustrating an example of an output-stationary SA-based MMA unit 6a of a related example.

In the SA-based MMA unit 6a illustrated in FIG. 3, PEs 60 each of which has an FMA unit are arranged in an L×M array. The cross-hatched rectangles and the hatched rectangles in FIG. 3 each represent a FF.

Elements in each of one column of a₊ₖ and one row of bₖ₊ are skewed and input in row and column directions, respectively, and transferred in a bucket-brigade manner. The arrows with reference signs A1 and A2 in FIG. 3 are similar to the arrows with reference signs A1 and A2 in FIG. 1, and indicate that the matrix A and B are inverted and transferred in a bucket-brigade manner.

A PE 60 at the intersection point of transfer carries out multiplication and outputs the cumulative sum (accumulation) to cᵢⱼ. This multiplication and accumulation is repeated until the matrices A and B pass through the array of the PEs 60. The PE 60 includes a multiplier 61 and an adder 62 for EMA operation, and an accumulator (Acc) 63.

### EMBODIMENT

Hereinafter, an embodiment will now be described with reference to the accompanying drawings. However, the following embodiment is merely illustrative and is not intended to exclude the application of various modifications and techniques not explicitly described in the embodiment. Namely, the present embodiment can be variously modified and implemented without departing from the scope thereof. Further, each of the drawings can include additional functions not illustrated therein to the elements illustrated in the drawing.

Hereinafter, like reference numbers designate the same or substantially same elements in the drawings, so repetitious description will be omitted here.

### Example of Embodiment

The MMA unit according to an example of the embodiment has a two-tiered structure of a SIMD-based and an SA-based unit. The lower tier is a SIMD-based unit composed of an l×m array of PEs, which is referred to as a processing tile (PT). The upper tier is an SA-based unit that has these PTs as elements.

The MMA unit according to an example of the embodiment may be regarded as an “SA of block matrices”, in which each matrix element for SA is a block matrix, and the matrix product of each block matrix is calculated by the PT of the SIMD-based unit.

The PT is assumed to have a size that is the most efficient (e.g., l=m= about 8 to 16) and the SA is composed of an array of PTs. This makes the entire arithmetic unit possible to be area- and energy-efficient, and scalable.

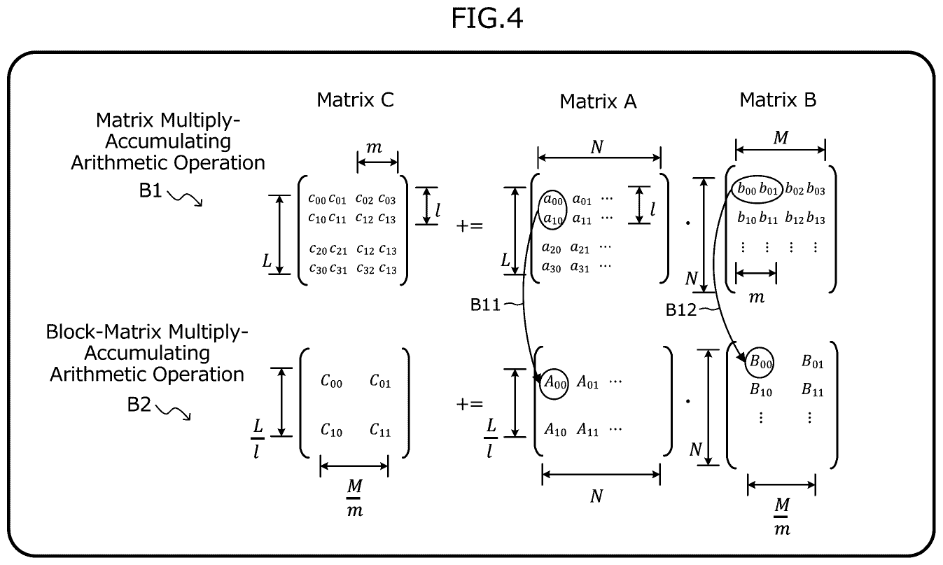

In. FIG. 4, the reference signs B1 and B2 represent an MMA operation and the equivalent MMA operation based on block matrices.

In reference sign B1, the matrices A, B, and C are L×N, N×M, and L×M, respectively.

The expression of an MMA operation illustrated in the reference sign B1 is transformed into the expression of the block MMA operation indicated by the reference sign B2 by block-division of the matrix A into an l×1 column vectors Aᵢₖ (see, the reference sign B11) and block-division of the matrix B into l×m row vectors Bₖⱼ (see, the reference sign B12).

As a result, in the reference sign B2, the matrices A, B, and C are (L/l)×N, N×(M/m), and (L/l)×(M/m), respectively.

An block MMA operation is successfully accomplished by regarding the blocks Aᵢₖ and Bₖⱼ as elements, where the products of these elements are the outer products of the blocks Aᵢₖ and the blocks Bₖⱼ.

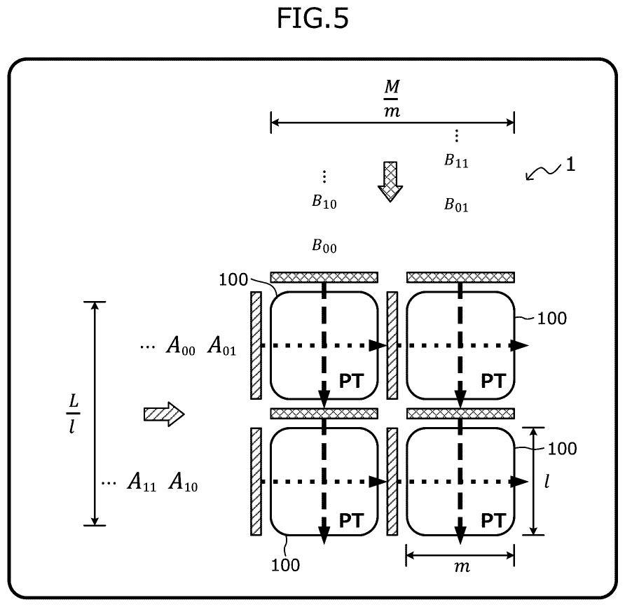

FIG. 5 is a diagram illustrating an example of operation of a block SA unit 1 according to an example of an embodiment.

The block SA unit 1 illustrated in FIG. 5 is an example of an arithmetic unit, and includes an array of PTs 100 (2×2 in the example illustrated in FIG. 5). The cross-hatched and rectangles in FIG. 5 each represent FFs.

In FIG. 5, the PT 100 are arranged in an L/1 rows by an M/m columns. For example, two rows by two columns if L=M=4 and l=m=2.

Elements of each of one column of A₊ₖ and one row of Bₖ₊ are skewed, and transferred in a bucket-brigade manner to the consecutive PTs. In each PT 100, a SIMD-based MMA unit calculates the outer products, which are accumulated in the PTs.

Between the consecutive PTs 100 (Tu and Td) in the block SA unit 1, Tu can transfers a block to Td before Tu finishes the accumulation of outer products of the block.

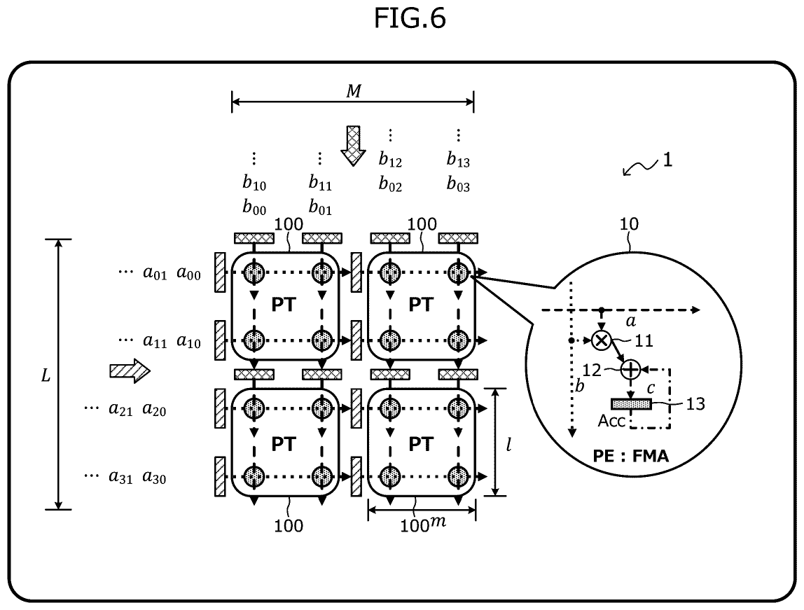

FIG. 6 is a diagram schematically illustrating an example of the configuration of the block SA unit 1 of the embodiment.

In the example illustrated in FIG. 6, the block SA unit 1 includes L×M PEs 10 (in the example of FIG. 6, four rows by four columns (4×4)) each of which has an EMA unit. Among L×M PEs 10, l×m (in the example of FIG. 6, two rows by two columns) PEs 10 are arranged in a single PT 100. The cross-hatched and hatched rectangles in FIG. 6 represent FFs.

The PE 10 includes a multiplier 11 and an adder 12 for EMA operation, and an Acc 13.

In the block SA arithmetic unit 1 illustrated in FIG. 6 thins out FFs in each PT 100 (i.e., the l×m PEs 10) as compared with the structure of the SA-based unit of the related example illustrated in FIG. 3.

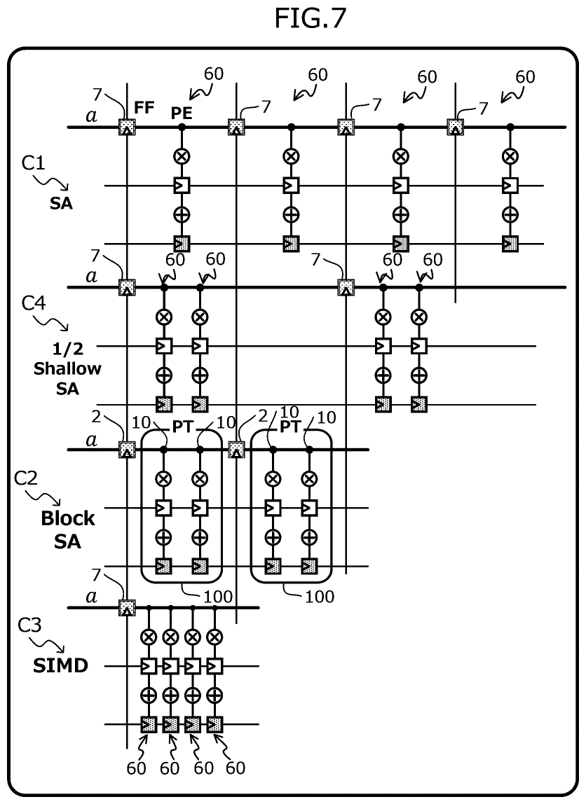

FIG. 7 is a diagram illustrating a comparison of pipelined operation of MMA units of respective schemes.

The reference sign C1, C2, and C3 represent pipelines of the SA-based MMA unit 6a of the related example, the block SA arithmetic unit 1 of the embodiment, and the SIMD-based MMA unit 6 of the related example, respectively. In addition, the reference sign C4 represents ½ shallowed pipeline of the SA-based MMA unit.

In FIG. 7, the horizontal direction indicates a pipeline for data transfer of a and b to the consecutive PEs (for simplicity, only data transfer of a is presented), and the vertical direction represents a pipeline of EMA operations.

In the SA-based MMA unit 6a represented by the reference sign C1, an FF 7 is horizontally inserted between each PE 60.

In the block SA unit 1 represented by the reference sign C2, the FF 2 is inserted for every several PEs 10 (more correctly, for every PT 100). This configuration broadcasts data only to the PEs 10 in each PT 100.

In the SIMD-based MMA unit 6 represented by the reference sign C3, no FF 7 is inserted horizontally between the PEs 10, and accordingly data is broadcasted to all the PEs 60.

In the MMA unit represented by the reference sign C4 represents ½ shallow pipelining. In a shallowed pipeline, some FFs 7 are thinned out and the number of stages comes to be 1/s, and the clock rate and throughput also come to be 1/s.

Signal propagation in the horizontal direction in the drawing is accomplished in a bucket-brigade transfer of data a and b. Although only data a appears in FIG. 7 for simplification, the data b propagates in the same manner. In the horizontal direction, only wire-level signal propagation without any logic is carried out, which is not critical.

On the other hand, the signal propagation in the vertical direction in the drawing is critical because the complex EMA logic is inserted in the vertical direction. In the PE 60 in FIG. 7, one cycle is assigned to each of the multiplier (x) and the adder (+).

In the block SA unit 1 represented by the reference sign C2, bucket-brigade transfer of data a and b is not critical, and some FFs are thinned out. FFs are not inserted between the consecutive PEs 10 in PTs 100, but FFs 2 are inserted between the consecutive PTs 100. The consecutive PTs 100 operate with one-cycle delay and the latency is shortened to 1/l and 1/m. The PEs 10 in a PT are automatically parallelized, because they originally have no dependency between them.

In contrast, in the block SA unit 1 represented by the reference sign C2, the FFs between the multiplier and adder, which reside the critical paths in the EMA units, are not thinned out. Accordingly, the clock rate and throughput remain unchanged.

### Modification

The MMA unit in the modification transforms the PE array of each PT into a “rectangular shape”. For example, the number of rows of a PE array is reduced to 1/r (r>1) without reducing the target matrix size (=total number of accumulators). Although the number of PEs (the number of FMAs) is reduced to 1/r, each PE includes r accumulators and executes r EMA operations each time single outer-product operation is executed.

According to the MMA unit of the modification, the throughput of the entire MMA unit is reduced to 1/r, but the bucket-brigade transfer throughput for data a or b is also reduced to 1/r. If both rows and columns are reduced to 1/√r to reduce the number of PEs to 1/r, the bucket-brigade transfer throughput is reduced to only 1/√r.

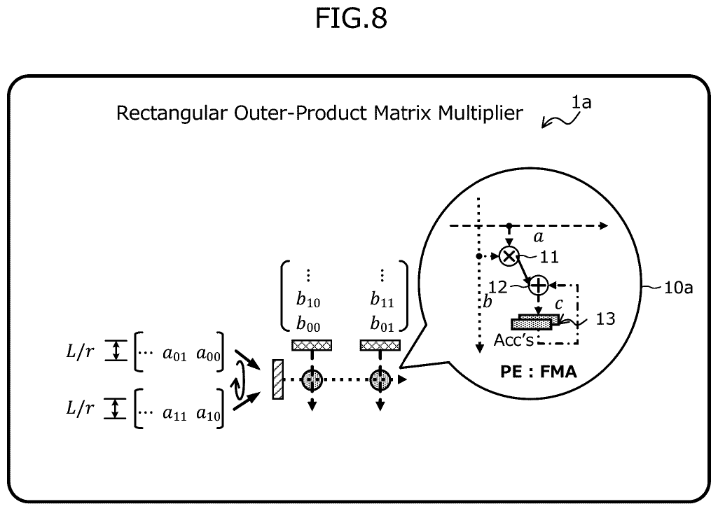

FIG. 8 is a diagram schematically illustrating an example of the configuration of a rectangular MMA unit 1a.

FIG. 8 illustrates an example of dividing of [aᵢₖ] under a state where L=M=2 and r=2. The numbers of PEs 10 is reduced to 1/r=½, and each PE 10a includes r=2 accumulators 13, and FMA operation is carried out r=2 times each time a single outer product is calculated. The r=2 operations with [aᵢₖ] are interleaved.

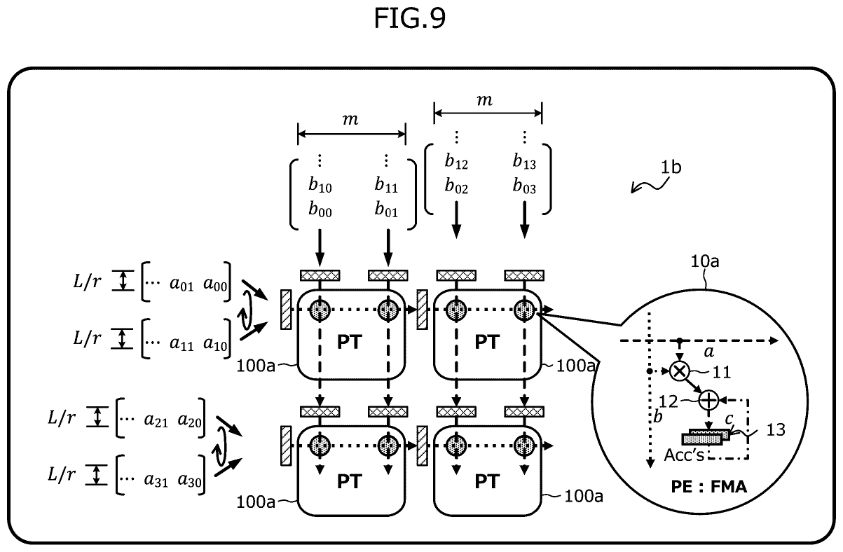

FIG. 9 is a diagram schematically illustrating an example of the configuration of rectangular MMA units 1b including PTs 100a according to the modification.

In the example of FIG. 9, the rectangular MMA units are applied to the PTs 100a of a block SA MMA unit.

Each PT 100a includes an array of A×p PEs 10a. In a rectangular MMA unit 1b, one of λ or μ satisfies λ=l or μ=m and the other is an integer of 2≤λ<l or 2≤μ<m, and the cumulative sum of l×m outer product is calculated in multiple steps.

In bucket-brigade transfer of data a and b, the bit width comes to be 1/r, and transfer to the consecutive PT 100a takes r cycles per block Aᵢₖ and Bₖⱼ. Nevertheless, also in this modification, the consecutive PT 100a operates with one-cycle delay like the embodiment.

Since the PT 100a is SIMD-based, the same data b needs to be supplied over r cycles, during which interleaved EMA operations are performed on the different r rows of data a. Accordingly, buffers are provided for [bₖⱼ] in order to align its timing with that of [aᵢₖ].

### Effect

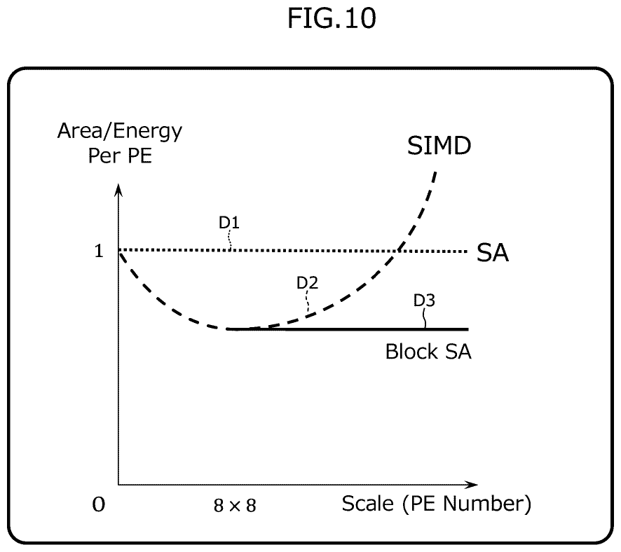

FIG. 10 is a graph illustrating a comparison of area- or energy-efficiency between the MMA unit 6, 6a in the related examples and the block SA arithmetic unit 1 in the embodiment.

The SA-based MMA unit 6a of the related example represented by the reference sign D1 requires the FF 7 for bucket-brigade transfer for every PE 60, and shows a constant efficiency regardless of the scale. That is, the SA-based MMA unit 6a is inefficient but scalable.

The SIMD-based MMA unit 6 of the related example represented by the reference sign D6 has higher efficiency at a small scale because it has less FFs 7 than the SA-based unit, but shows lower efficiency at a large sale because the broadcasting targets increase. That is, the SIMD-based MMA unit 6 is efficient but not scalable.

The block SA arithmetic unit 1 of the embodiment represented by D3 can keep the highest-efficiency point of the SIMD-based unit even at larger scales. That is, the block SA unit 1 is efficient and scalable.

According to the MMA unit of the above-described embodiment, for example, the following advantageous effects can be achieved.

The block SA arithmetic unit 1 divides the matrix A into blocks Aᵢₖ, which are l×1 column vectors, and divides the matrix B into block Bₖⱼ, which are l×m row vectors. In addition, the block SA arithmetic unit 1 accumulates the outer products of the block Aᵢₖ and the block Bₖ in a PT including l×m PEs 1, and performs a systolic array arithmetic operation of the output stationery scheme in the entire arithmetic unit.

This makes it possible to enhance the area- and energy-efficiency of large-scale MMA units.

When the matrix A is an L×N matrix (i.e., matrix of L rows by N columns), the matrix B is an N×M matrix, and the matrix C is an L×M matrix, the matrix A is divided into blocks Aᵢₖ and therefore is transformed into a matrix of L/l rows by N columns, the block B is divided into blocks Bₖⱼ and therefore transformed into a matrix of N rows by M/m columns, and the matrix C is transformed into a matrix of L/l rows by M/m columns (i.e., matrix of (L/l)×(M/m)).

This makes it possible to accurately divide a matrix into blocks.

Between the consecutive PTs 100 (Tu and Td) in the block SA arithmetic unit 1, Tu transmits the block to Td before Tu finishes the accumulation of outer products of the block. Typically, the PT 100 (Tu) transmits a block to the PT 100 (Td) at the next cycle of a cycle in which the Tu receives the same block, and the PT 100 (Tu) and the PT 100 (Td) perform pipelining operations with one-cycle offset.

As a result, pipelining operations in a unit of a PT can be performed, and can reduce the latency.

The PT 100a includes an array formed of λ×μ PEs 10a. In a rectangular outer-product matrix multiplier 1b, when one of λ or μ satisfies λ=l or μ=m and the other is an integer of 2≤λ<l or 2≤μ<<m, the cumulative sum of l×m outer products is calculated in multiple steps.

This makes it possible to reduce the bucket-brigade transfer throughput of the matrices A and B.

### MISCELLANEOUS

The disclosed techniques are not limited to the embodiment described above, and may be variously modified without departing from the scope of the present embodiment. The respective configurations and processes of the present embodiment can be selected, omitted, and combined according to the requirement.

According to as aspect, the area and electricity efficiency can be enhanced in a large-scale arithmetic unit.

Throughout the descriptions, the indefinite article “a” or “an”, or adjective “one” does not exclude a plurality.

All examples and conditional language recited herein are intended for the pedagogical purposes of aiding the reader in understanding the invention and the concepts contributed by the inventor to further the art, and are not to be construed limitations to such specifically recited examples and conditions, nor does the organization of such examples in the specification relate to a showing of the superiority and inferiority of the invention. Although one or more embodiments of the present inventions have been described in detail, it should be understood that the various changes, substitutions, and alterations could be made hereto without departing from the spirit and scope of the invention.

What is claimed is:

1. An arithmetic unit that executes matrix multiplication operation C=A×B or matrix multiply-accumulate operation C=A×B+Cin, the arithmetic unit comprising:
the matrix A regarded as being divided into blocks Aᵢₖ each being an l×1 column vector;
the matrix B regarded as being divided into blocks Bₖⱼ each being a l×m row vector;
accumulating l×m outer products of the blocks Aᵢₖ and the blocks Bₖⱼ in a processing tile including l×m processing elements performing element-wise multiply-accumulate operation on the matrices; and
executing output-stationary systolic-array-based operation in units of the processing tile across an entirety of the arithmetic unit.

2. The arithmetic unit according to claim 1, wherein
when the matrix A is an L×N matrix, the matrix B is a N×M matrix, and the matrix C is a L×M matrix,
the matrix A comes to be an (L/l)×N matrix as a result of the dividing into the blocks Aᵢₖ,
the matrix B comes to be an N×M/m matrix as a result of the dividing into the blocks Bₖⱼ, and
the matrix C comes to be an (L/l)×(M/m) matrix.

3. The arithmetic unit according to claim 1, wherein
between a processing tile Tu and a processing tile Td among a plurality of the processing tiles, the processing tile Td consecutive to the processing tile Tu,
the processing tile Tu transmits the blocks to the processing tile Td before the processing tile Tu finishes the accumulating of the l×m outer products of the blocks.

4. The arithmetic unit according to claim 2, wherein
between a processing tile Tu and a processing tile Td among a plurality of the processing tiles, the processing tile Td consecutive to the processing tile Tu,
the processing tile Tu transmits the blocks to the processing tile Td before the processing tile Tu finishes the accumulating of the l×m outer products of the blocks.

5. The arithmetic unit according to claim 1, wherein
the processing tile includes an array formed of λ×μ of the processing elements,
one of λ and μ satisfies λ=l or μ=m and another one is an integer satisfying 2≤λ<l or 2≤μ<m, and
the accumulating of the l×m outer products is carried out in a plurality of steps.

6. The arithmetic unit according to claim 2, wherein
the processing tile includes an array formed of λ×μ of the processing elements,
one of λ and μ satisfies λ=l or μ=m and another one is an integer satisfying 2≤λ<l or 2≤μ<m, and
the accumulating of the l×m outer products is carried out in a plurality of steps.
